(19) United States
(12) Patent Application Publication
(10) Pub. No.: US 2026/0105289 A1
(43) Pub. Date: Apr. 16, 2026

(54) SPATIAL-TEMPORAL GRAPH CONVOLUTION-BASED ELECTRIC VEHICLE CHARGING DEMAND PREDICTION METHOD AND APPARATUS

(71) Applicant: CHUNG ANG UNIVERSITY INDUSTRY ACADEMIC COOPERATION FOUNDATION, Seoul (KR)

(72) Inventors: Mun Kyeom KIM, Seoul (KR); Hyung Joon KIM, Seoul (KR)

(21) Appl. No.: 19/175,640

(22) Filed: Apr. 10, 2025

Related U.S. Application Data
(63) Continuation of application No. PCT/KR2025/002646, filed on Feb. 26, 2025.

(30) Foreign Application Priority Data
Oct. 15, 2024 (KR) 10-2024-0139915

(51) Int. Cl. G06N 3/049; G06N 3/0442; G06N 3/045; G06N 3/0464; G06N 3/0499; G06Q 50/06

(52) U.S. Cl. CPC G06N 3/049; G06N 3/0442; G06N 3/045; G06N 3/0464; G06N 3/0499; G06Q 50/06

(57) ABSTRACT

Spatial-temporal graph convolution-based electric vehicle charging demand prediction method and apparatus are disclosed. The spatial-temporal graph convolution-based electric vehicle charging demand prediction method, comprising: (a) dividing EVCS (Electric Vehicle Charging Station) related data into a dynamic graph and temporal sequence data; (b) generating spatial feature information by applying the dynamic graph and temporal sequence data to a first-deep learning model based on relational graph convolution; (c) generating temporal feature information by applying the dynamic graph and temporal sequence data to a second-deep learning model based on bidirectional LSTM; and (d) outputting hourly EVCS charging demand predictions by combining the spatial feature information and the temporal feature information.

### CROSS-REFERENCE TO RELATED APPLICATION

This application is a bypass continuation of pending PCT International Application No. PCT/KR2025/002646, which was filed on Feb. 26, 2025, and which claims priority to Korean Patent Application No. 10-2024-0139915, which was filed in the Korean Intellectual Property Office on Oct. 15, 2024. The disclosures of which are hereby incorporated by reference in their entireties.

### STATEMENT REGARDING PRIOR DISCLOSURES BY THE INVENTOR OR A JOINT INVENTOR

At least one inventor or joint inventor of the present disclosure has made related disclosures in a research paper (IEEE Transactions on Smart Grid, VOL. 15, NO. 4, JULY 2024) on Feb. 26, 2024, which was included in the information disclosure statement submitted with this application.

### TECHNICAL FIELD

The present disclosure relates to a spatial-temporal graph convolution-based electric vehicle charging demand prediction method and apparatus.

### BACKGROUND ART

ELECTRIC vehicles (EVs) have been promoted as a promising solution for reducing global CO2 emissions and mitigate climate change. According to the International Energy Agency, the number of EVs worldwide is expected to increase to more than 240 million by 2030. Although the rapid growth in the popularity of EVs has led to an increase in charging demand, the stochastic nature of the charging behavior of EV users in time and space can lead to uncertainty in the charging demand of electric vehicle charging stations (EVCSs), which causes charging fluctuation and operational risks for profit maximization. Specifically, as the retail electricity markets are further liberalized for customers to manage their electricity cost with various options, it is essential to forecast future EVCS charging demands to participate in the power market and accommodate charging demand efficiently. Thus, it is imperative to develop an accurate forecasting model to enable EVCSs to cope with the uncertainties related to EV demands, ensure reliable and economic operation, and further increase their deployment.

Several predictive models have been developed to forecast the charging demand of electric vehicle charging stations (EVCS), including statistical methods, machine learning-based methods, and deep learning-based methods. Statistical models primarily include Monte Carlo simulations, fuzzy linear regression, quantile linear regression, autoregressive integral moving averaging (ARIMVA), and the Kalman filter method. However, these models assume that the original data are stationary and therefore have limitations in dealing with non-linear problems. In addition, the potential dependence between multiple time series under complex charging conditions has been ignored. Although advanced statistical approach such as fuzzy set with model predictive control has been proposed in, obtaining a fuzzy membership function could be difficult and may be unsuitable for addressing highly and exceptional uncertain circumstances with numerous variables.

To overcome the limitations of statistical models, machine learning-based models, which are more capable of capturing non-linear complex relationships, have been developed. Recent approaches include support vector regression, kernel-based methods, nearest-neighbor analysis, and random forests. Although these models have proven to be more efficient than statistical models, their ability to map attributes is limited, in particular when dealing with high-dimensional EV time series in which the number of samples is large or the relationship between the attributes is more complex. Regardless of the degree to which the number of data samples or attributes increases, such models are generally stable and vary only slightly in terms of accuracy

Deep learning-based models have demonstrated superior performance because they can be trained with complex data in large quantities. Recurrent neural networks (RNNs) and their variants such as long short-term memory (LSTM) and gated recurrent units have been widely utilized in EV charging demand forecasting. However, RNN and their variants consider only the temporal dependencies of charging demand and ignore the spatial dependencies within an EVCS network, sparse relational patterns exist between different nodes and spatial dependencies have a significant influence on demand forecasting. For example, the EVCSs within a given block might exhibit similar consumption patterns because they have similar traffic patterns and weather effects.

To capture the spatial and temporal dependencies simultaneously, convolutional NN (CNNs) and their variants have been employed along with RNN-based model. In other words, a CNN with Bidirectional gated recurrent unit (Bi-GRU) has been used to capture the spatial temporal dependencies for demand prediction. Additionally, an extended Conv-LSTM combined with a residual network has been proposed as a fully convolutional neural network (FCN-CE-LSTM) to capture the spatio-temporal dependencies for demand prediction. However, CNN-based models can only consider the absolute spatial relationships among EVCS on a two-dimensional Euclidian space. Specifically, CNNs require regular grid data as inputs, which does not conform well to the irregularity of typical EVCS points on a map. In this regard, EVCS data must be forcibly sampled into regular grid formats by the CNN, potentially destroying the original spatial information of the EVCSs. Thus, the ideal method for representing EVCS data is to model it as a graph in its original spatial form.

Accordingly, a new type of neural network, graph convolutional network (GCN), has been proposed. To map irregular datasets using graphs, the input data of the GCN comprise a set of nodes and edges that represent, respectively, the EVCS charging points and relationships between them. Given the inherent graph structure of an EVCS network, a GCN can preserve a realistic topology and extract the spatial dependencies between EVCSs by aggregating the node information through graph convolution. traffic GCN-LSTM model was proposed to forecast traffic states by learning the interactions between roadways in the traffic network. A gated spatial-temporal graph neural network is proposed for multiple bus load forecasting. A similar-weight spatial-temporal graph was constructed to reflect the coupling relationship between loads of each bus.

However, conventional GCNs employ a fixed adjacency matrix calculated from prior knowledge to build graphs. Through this approach, spatiotemporal dependencies can be captured by global fixed parameters, and the heterogeneity in the temporal and spatial dimensions can be overlooked. To overcome this problem, a self-adaptive adjacency matrix has been proposed to capture the hidden spatial dependencies of different nodes without prior knowledge. Similarly, optimized GCN-based RNN was proposed to learn the relationship among the road regions from the traffic data. In addition, multiple GCN-RNN (MGCRNN) have been used to capture spatial and other heterogeneous interstation correlations. To extract location-wise spatial interactions, a bidirectional adjacency matrix has also been developed, and a heterogeneous spatial-temporal graph convolutional network was proposed to predict charging demand of EV Here, a geographic and a demand graph were used to construct the spatial correlations between different charging regions.

Meanwhile, recently, various open-source forecasting tools such as Global Change analysis model, total electricity load model, and EVI-Pro Lite have been developed to project spatial temporal transportation charging demand profiles. Specifically, a spatially distributed statistical downscaling approach was proposed to project annual transportation energy into the hourly time series charging demand load profiles, but although spatial temporal dependencies of EV charging demand have been considered in these tools, they are mainly designed for county-, state- and Balancing Authority scales and these models could not be directly used for EVCS aggregator to predict individual EVCS charging demand and participate in actual retail electricity market.

Despite recent advances, the existing models have four major limitations. First, although improving the adjacency matrices has elucidated data processing, their inter-node relations are static and ignore other semantic factors that can be used to measure spatial relations between nodes. In particular, EVCS demand is influenced by not only static attribute referred as node distance but also dynamic attributes such as station correlation, charging patterns, weather, day of the week, and holidays. These factors should be considered comprehensively along with static attributes when constructing graphs. In addition, the factors affecting charging prediction in conventional adjacency matrices remain unclear. Second, existing RNNs achieve maximum predictability by learning the historical charging demand to capture temporal dependencies. However, EVCS demand also depends on exogenous factors such as time of day, day of week, past EVCS demand state, and average charging rates. Third, to capture spatiotemporal dependencies, previous studies combined GCN/CNN and RNN models sequentially. However, this sequential structure can distort the extracted dependencies during conversion of the convolution results, leading to information loss and increase forecasting uncertainty. Thus, a new deep learning architecture is required to preserve the effectiveness of spatial and temporal features and produce integrate outputs of these in a complementary manner for EVCS demand forecasting. Finally, existing studies have not considered participating actual energy market to validate the applicability and robustness of the proposed model for real application.

### DISCLOSURE

### Technical Problem

The present disclosure provides a spatio-temporal graph convolution-based electric vehicle charging demand prediction method and apparatus.

In addition, the present disclosure provides a spatio-temporal graph convolution-based electric vehicle charging demand prediction method and apparatus capable of simultaneously capturing temporal and spatial dependencies through a mutually residual graph convolution combined bidirectional model an innovative parallel-structured charging demand prediction model that enables EVCS owners to actively participate in the energy market.

### Technical Solution

According to an aspect of the present disclosure, there is provided a spatial-temporal graph convolution-based electric vehicle charging demand prediction method.

According to an embodiment of the present disclosure, there is provided a spatial-temporal graph convolution-based electric vehicle charging demand prediction method, comprising: (a) dividing EVCS (Electric Vehicle Charging Station) related data into a dynamic graph and temporal sequence data; (b) generating spatial feature information by applying the dynamic graph and temporal sequence data to a first-deep learning model based on relational graph convolution; (c) generating temporal feature information by applying the dynamic graph and temporal sequence data to a second-deep learning model based on bidirectional LSTM; and (d) outputting hourly EVCS charging demand predictions by combining the spatial feature information and the temporal feature information.

The dynamic graph is a temporal graph that includes location information for each EVCS over a continuous time series and spatial correlations related to charging demand data.

The temporal sequence data is a mutual adjacency matrix generated using static attributes based on the location information for each EVCS and dynamic attributes that affect the charging demand of the EVCS.

The mutual adjacency matrix is generated by calculating distances between EVCSs using the location information of each EVCS, constructing a distance matrix using the distances between EVCSs, forming a dynamic feature correlation matrix based on a charging demand relationship with adjacent EVCSs using Pearson correlation coefficients, constructing a charging comfort matrix based on weather information, constructing a charging exogenous factor matrix according to weekday information considering holidays and commuting, and combining the distance matrix, the dynamic feature correlation matrix, the charging comfort matrix and the charging exogenous factor matrix.

The first-deep learning model derives a residual element using the temporal graph and the mutual adjacency matrix, and generates the spatial feature information by adding the residual element to the result of applying the temporal graph and the mutual adjacency matrix to a relational graph convolution-based model.

The first deep-learning model comprises a first graph convolutional network block configured to receive the temporal graph and the mutual adjacency matrix as input, and extract a local spatial feature value for local spatial dependency that reflects a charging demand pattern of EVCSs located at adjacent distances; and a second graph convolutional network block configured to extract a global spatial feature value for global spatial dependency that reflects a state and a charging demand pattern of EVCSs located at distant positions using the local spatial feature value which is the output of the first graph convolutional network block, wherein the spatial feature information is generated by adding the residual element to the global spatial feature value.

The temporal sequence data is a day-type tendency feature sequence that includes a time of day, a day of week, a past charging demand status and average charging rates.

The second-deep learning model comprises a multi-layer feed-forward neural network model configured to receive the temporal sequence data and generate an output vector reflecting an EVCS demand pattern; and a bidirectional LSTM model configured to receive the temporal graph and output a temporal feature vector; wherein the temporal feature information is generated by combining the output vector of the multi-layer feed-forward neural network model and the temporal feature vector of the bidirectional LSTM model.

According to another aspect of the present disclosure, there is provided an apparatus for performing a spatial-temporal graph convolution-based electric vehicle charging demand prediction method.

According to an embodiment of the present disclosure, there is provided a computing device, comprising: a preprocessing unit configured to divide EVCS (Electric Vehicle Charging Station) related data into a dynamic graph and temporal sequence data; and a prediction model unit configured to generate spatial feature information by applying the dynamic graph and temporal sequence data to a first-deep learning model based on relational graph convolution, generate temporal feature information by applying the dynamic graph and the temporal sequence data to a second-deep learning model based on bidirectional LSTM, and output hourly EVCS charging demand predictions by combining the spatial feature information and the temporal feature information.

### Advantageous Effects

By providing a spatial-temporal graph convolution-based electric vehicle charging demand prediction method and apparatus according to an embodiment of the present disclosure, temporal and spatial dependencies can be simultaneously captured through the Mutual Residual Graph Convolution-Coupled Bidirectional Model, an innovative parallel-structured charging demand forecasting model that enables EVCS owners to actively participate in the energy market.

### BRIEF DESCRIPTION OF THE DRAWINGS

FIG. 1 is a flowchart illustrating a spatial-temporal graph convolution-based electric vehicle charging demand prediction method according to an embodiment of the present disclosure.

FIG. 2 is a diagram illustrating graph data according to an embodiment of the present disclosure.

FIG. 3 is a diagram illustrating the generation of a mutual adjacency matrix according to an embodiment of the present disclosure.

FIG. 4 is a diagram illustrating the structure of a first-deep learning model according to an embodiment of the present disclosure FIG. 5 is a diagram illustrating the Bi-LSTM model according to an embodiment of the present disclosure.

FIG. 6 is a diagram illustrating the structure of a second-deep learning model according to an embodiment of the present disclosure.

FIG. 7 is a diagram illustrating the overall structure of the charging demand prediction model according to an embodiment of the present disclosure.

FIG. 8 is a diagram illustrating an example of a market operation framework according to an embodiment of the present disclosure.

FIG. 9 is a block diagram schematically illustrating the internal configuration of a computing device according to an embodiment of the present disclosure.

### BEST MODE

In the present specification, singular forms include plural forms unless the context clearly indicates otherwise. In the specification, the terms “composed of” or “include,” and the like, should not be construed as necessarily including all of several components or several steps described in the specification, and it should be construed that some component or some steps among them may not be included or additional components or steps may be further included. In addition, the terms “ . . . unit’, “module”, and the like disclosed in the specification refer to a processing unit of at least one function or operation and this may be implemented by hardware or software or a combination of hardware and software.

Hereinafter, the embodiments of the present disclosure will be described in detail with reference to the accompanying drawings.

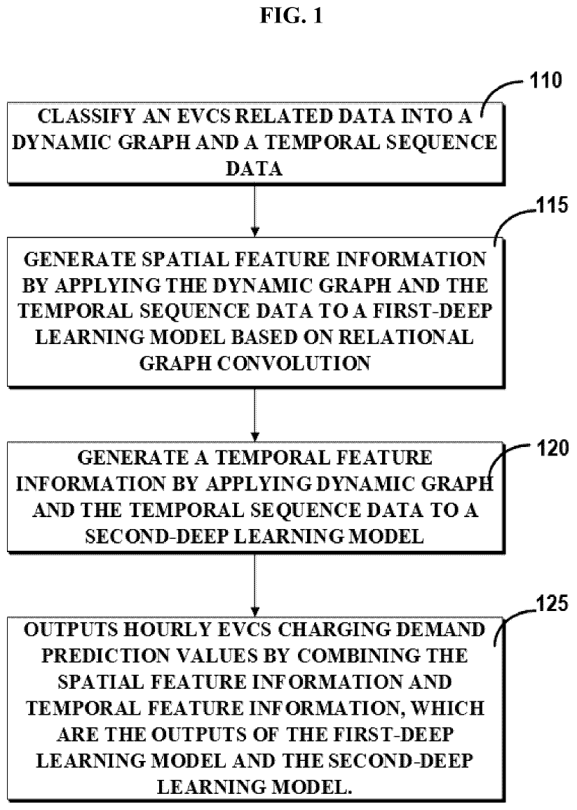

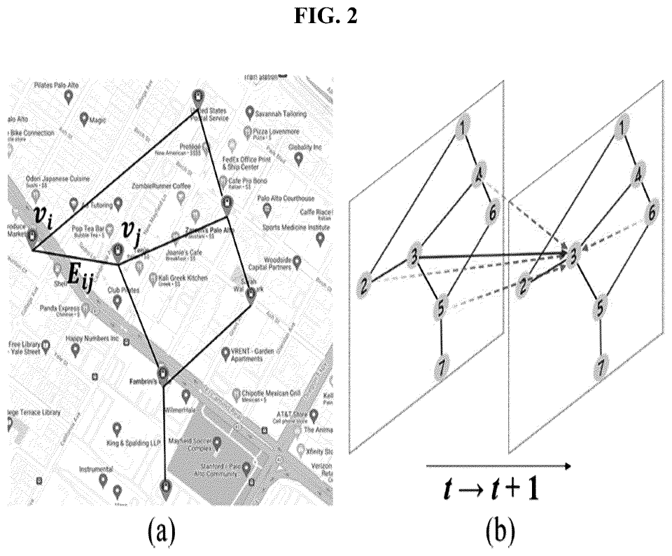

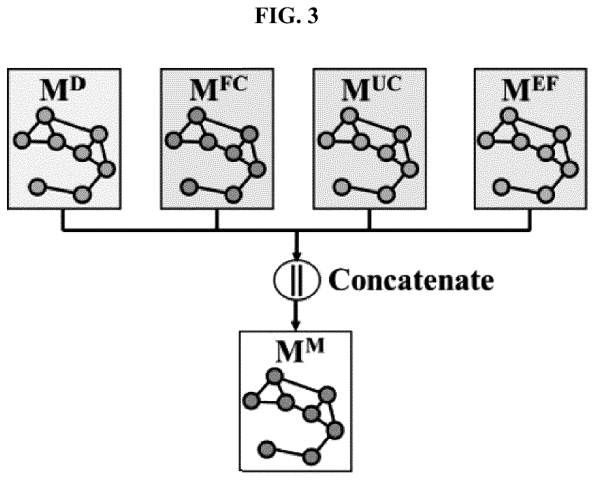

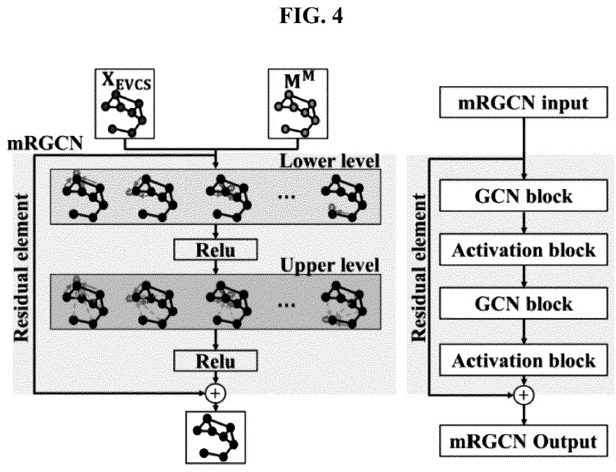

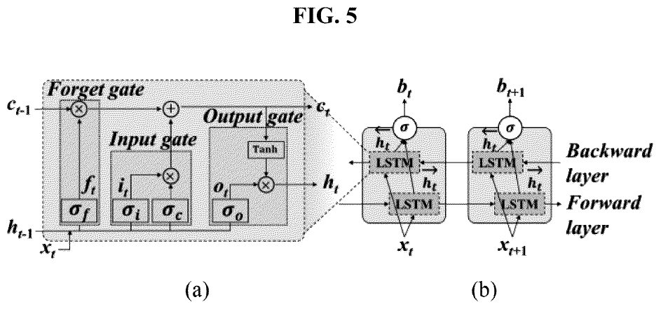

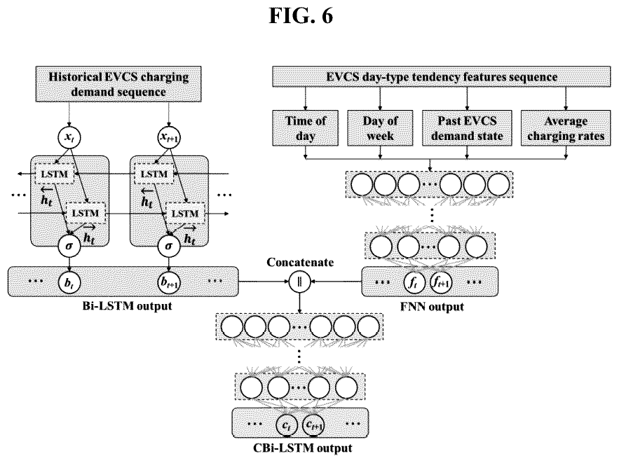

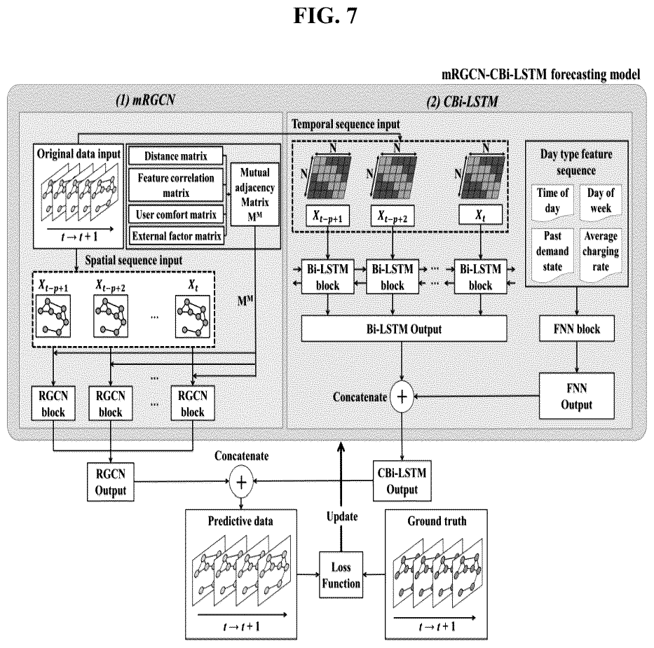

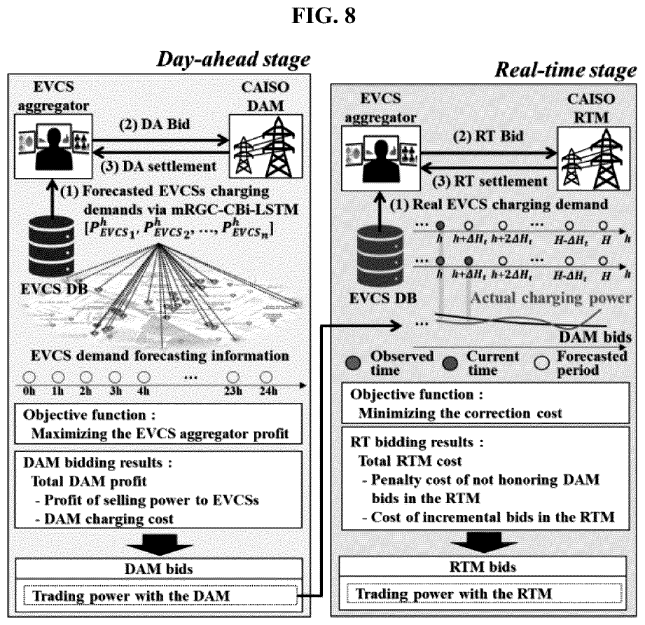

FIG. 1 is a flowchart illustrating a spatial-temporal graph convolution-based electric vehicle charging demand prediction method according to an embodiment of the present disclosure, FIG. 2 is a diagram illustrating graph data according to an embodiment of the present disclosure, FIG. 3 is a diagram illustrating the generation of a mutual adjacency matrix according to an embodiment of the present disclosure, FIG. 4 is a diagram illustrating the structure of a first-deep learning model according to an embodiment of the present disclosure, FIG. 5 is a diagram illustrating the Bi-LSTM model according to an embodiment of the present disclosure, FIG. 6 is a diagram illustrating the structure of a second-deep learning model according to an embodiment of the present disclosure, FIG. 7 is a diagram illustrating the overall structure of the charging demand prediction model according to an embodiment of the present disclosure, and FIG. 8 is a diagram illustrating an example of a market operation framework according to an embodiment of the present disclosure.

In step 110, the computing device (100) can classify an EVCS related data into a dynamic graph and a temporal sequence data.

A more detailed explanation will be provided regarding this.

An undirected graph G=(V, E, A) may be generated using EVCS location and charging demand data. For example, in FIG. 2(a), each EVCS is represented as a point. Each point can be regarded as an EVCS node, and its relationship can be described by G. Where, V={v₁, v₂, . . . , vₘ} denotes a complete set of m EVCS nodes, and E denotes a set of edges, and A denotes an adjacency matrix. And n represents the number of features of each node representing spatial relationships between EVCS nodes.

In this way, after generating the undirected graph for each EVCS, the spatio-temporal correlation between the EVCS nodes in a continuous time series from time t to (t+1) can be represented as shown in FIG. 2(b). For example, v₃ can obtain spatial correlations from nodes v₁, v₄, v₂ [symbol] v₆, which may potentially interact with it.

In FIG. 2(b), line represents the influence of node v₃ on itself during the next time step, which is represented as a temporal correlation.

Based on the graph transformation of the EVCS demand data, an EVCS demand forecasting problem can be formulated as a prediction, X(l+Δt), considering the EVCS graph {X(t)|t=0, 1, . . . , l}. Where, l and t represent a last recording time and a prediction time interval, respectively.

The conventional adjacency matrix A is intuitive but incomplete, leading to biased prediction results. Additionally, the adjacency matrix A neglects distance factors and correlations between EVCS nodes, and has limitations in mining node-related features. Additionally, EV user comfort and exogenous factors that can influence the EVCS demand are not considered, which affects the accuracy predictions. For example, the correlation between two EVCS does not increase even if the distance between the nodes is short. In addition, the charging availability of a given EVCS affects the demand of nearby and distance EVCSs, so an analysis of the data correlations between each set of EVCS nodes is required. Additionally, weather conditions may hinder EV owners from driving and using EVCSs, so the driving comfort of EV owners should be considered. Exogenous factors such as holidays and weekends may also affect travel purposes, distances, and EVCS demand. Thus, to improve the accuracy of charging demand prediction, a use of a single fixed adjacency matrix should be replaced with an approach that can consider mutual influences and mapping relations between nodes and the exogenous factors when accounting for spatial dependencies.

Thus, in an embodiment of the present disclosure, a mutual adjacency matrix (MAM) may be constructed using static and dynamic attributes to comprehensively consider the factors influencing EVCS demand.

A static factor can refer to static geographic information, such as the distance between nodes, where nodes located closer to each other generally exhibit a strong correlation. Dynamic factors can be used to represent feature correlations between nodes, EV user comfort and exogenous factors. These factors, which are time-varying determinants of EVCS conditions, can directly and indirectly influence EVCS demand.

According to an embodiment of the present disclosure, the MAM can be constructed using the distance matrix (the static factor) and three dynamic factor matrices (a feature correlation matrix, EV user comfort matrix, exogenous factor matrix). The following provides a more detailed explanation of the MAM construction.

### (1) the Distance Matrix Based on the Static Factor

The static attribute, referred to the distance between EVCS nodes, can directly represent the correlations of EV charging demand, with shorter distances having stronger correlations. Location information of each node such as longitude and latitude can be obtained from GPS data. Based on the location information P=(lonₜ, latₜ) of EVCS, the distance between EVCS nodes can be calculated using the Haversine formula as shown in Equation 1.

$$H ( \frac{d}{R} ) = H ( {lat}_{x} - {lat}_{y} ) + cos ( {lat}_{x} ) cos ( {lat}_{y} ) H ( \vert {lon}_{x} - {lon}_{y} \vert ) \qquad [ Equation 1 ]$$

$$H ( θ ) = {sin}^{2} ( \frac{θ}{2} ) = \frac{1 - cos θ}{2} \qquad [ Equation 2 ]$$

Where R=6371 km represents the Earth's radius, d represents a distance between x-th EVCS node and y-th EVCS node, which can be calculated as d=θ×R. Based on Equation 1 and Equation 2, a straight-line Dₛₜₗ can be calculated between two EVCS nodes. Once the distance between two EVCS nodes is calculated, the distance matrix M^{DM} can be represented as shown in Equation 3.

$${M}^{D} = ( \begin{matrix}0 & {w}^{D} ( 1 , 2 ) & … & {w}^{D} ( 1 , N ) \\ {w}^{D} ( 2 , 1 ) & 0 & … & {w}^{D} ( 2 , N ) \\ ⋮ & ⋮ & 0 & ⋮ \\ {w}^{D} ( N , 1 ) & {w}^{D} ( N , 2 ) & … & 0\end{matrix} ) \qquad [ Equation 3 ]$$

### (2) Construction of the Dynamic Feature Correlation Matrix, Charging Comfort Matrix, and Charging Exogenous Factor Matrix Based on the Dynamic Factors

Since the charging demand among various EVCSs exhibits high or low correlations, effectively capturing the charging demand correlation features is crucial. In an embodiment of the present disclosure, a Pearson correlation coefficient method can be used to calculate the charging demand correlation coefficients among various EVCS nodes. This can be described as follows.

$${w}^{FC} ( i , j ) = \frac{[ {\sum }_{l = 1}^{L} ( {x}_{l} - \overline{x} ) ( {y}_{l} - \overline{y} ) ]}{[ {σ}_{x} {σ}_{y} ]} \qquad [ Equation 4 ]$$

Where, xₗ and yₗ represent l-th feature of two nodes, and σₓ and σ_{y} represent standard deviations of the selected features. Based on Pearson correlation coefficient, the dynamic feature correlation matrix M^{FC} can be obtained as shown in Equation 5.

$${M}^{FC} = ( \begin{matrix}1 & {w}^{FC} ( 1 , 2 ) & … & {w}^{FC} ( 1 , N ) \\ {w}^{FC} ( 2 , 1 ) & 1 & … & {w}^{FC} ( 2 , N ) \\ ⋮ & ⋮ & 1 & ⋮ \\ {w}^{FC} ( N , 1 ) & {w}^{FC} ( N , 2 ) & … & 1\end{matrix} ) \qquad [ Equation 5 ]$$

Additionally, weather conditions can directly affect the charging demand of EVCS users. The weather conditions are time-varying determinant factors that determine driving condition, such as road conditions and driver visibility, and can affect the use EVs and EVCSs, as well as the actual travel intent. For example, the EVCS charging demand may decrease compared to sunny-weather during poor weather.

Thus, in an embodiment of the present disclosure, w^{UC}(i,j) is defined on [0, 1], better weather conditions in the current environment correspond to a value of w^{UC}(i,j) closer to 1, and vice versa for worse conditions. Specifically, w^{UC}(i,j) is used as a categorical vector that distinguishes between sunshine, cloudiness, overcast conditions, sprinkling to heavy rain, fogginess, the presence or absence of thunderstorms and cyclones to represent the comfort values of EV users under different weather conditions. Accordingly, a user charging comfort matrix M^{UC} can be obtained as shown in Equation 6.

$${M}^{UC} = ( \begin{matrix}{w}^{UC} ( 1 , 1 ) & {w}^{UC} ( 1 , 2 ) & … & {w}^{UC} ( 1 , N ) \\ {w}^{UC} ( 2 , 1 ) & {w}^{UC} ( 2 , 2 ) & … & {w}^{UC} ( 2 , N ) \\ ⋮ & ⋮ & {w}^{UC} ( 3 , 3 ) & ⋮ \\ {w}^{UC} ( N , 1 ) & {w}^{UC} ( N , 2 ) & … & {w}^{UC} ( N , N )\end{matrix} ) \qquad [ Equation 6 ]$$

Additionally, the exogenous factors such as public holidays and weekdays/weekends can influence the EVCS charging demand. For example, the EVCS demand on New Year's Day or on weekends will be much greater than on weekdays due to differences in user purposes, such as commuting and non-commuting travel. A categorical variable represented by w^{EF} can capture external attributes, such as whether a specific day is a holiday/weekend, and cab be expressed as shown in Equation 7. The exogenous factor matrix M^{EF} can be obtained as shown in Equation 8.

$${w}_{EF} ( i , j ) = \{ \begin{matrix}1 , & if t belongs to holidays or weekend \\ 0 , & otherwise\end{matrix} \qquad [ Equation 7 ]$$

$${M}^{EF} = ( \begin{matrix}{w}^{EF} ( 1 , 1 ) & {w}^{EF} ( 1 , 2 ) & … & {w}^{EF} ( 1 , N ) \\ {w}^{EF} ( 2 , 1 ) & {w}^{EF} ( 2 , 2 ) & … & {w}^{EF} ( 2 , N ) \\ ⋮ & ⋮ & {w}^{UC} ( 3 , 3 ) & ⋮ \\ {w}^{EF} ( N , 1 ) & {w}^{EF} ( N , 2 ) & … & {w}^{EF} ( N , N )\end{matrix} ) \qquad [ Equation 8 ]$$

As mentioned above, based on these static attributes and dynamic attributes, the mutual adjacency matrix (MAX) M^{M} can be obtained by combining the four matrices as shown in Equation 9. This can be visualized as shown in FIG. 3.

$${M}^{M} = {W}^{M} * ( ( {W}^{D} {M}^{D} ) ‖ ( {W}^{FC} {M}^{FC} ) ‖ ( {W}^{UC} {M}^{UC} ) ‖ ( {W}^{EF} {M}^{EF} ) ) + {b}_{M} \qquad [ Equation 9 ]$$

Where, W^{D}, W^{FC}, W^{UC} and W^{EF} represent learnable weights of the corresponding matrices, ∥ and * represent concatenation and convolution, respectively Additionally, W^{M} and bm represent the weights of the convolution output and the bias term of W^{M}, respectively.

In step 115, the computing device (100) can generate spatial feature information by applying the dynamic graph and the temporal sequence data to a first-deep learning model based on relational graph convolution. The structure of the first-deep learning model according to an embodiment of the present disclosure is shown in FIG. 4.

Referring to FIG. 4, the first-deep learning model can be configured to better capture local small changes in the matrix by combining graph convolution operations with residual elements. To achieve this, the first-deep learning model can derive residual elements using the dynamic graph and the temporal sequence data.

As shown in FIG. 4, the first-deep learning model may include two graph convolutional network blocks. In the graph convolutional network block, graph data is processed in the spectral domain.

Therefore, based on the mutual adjacency matrix (W^{M}), the normalized Laplacian matrix of the graph can be calculated as shown in Equation 10.

$${X}^{l + 1} = f ( {X}^{l} , {M}^{M} ) = f ( {\overline{D}}^{- 0.5} {\overline{M}}^{M} {\overline{D}}^{- 0.5} {X}^{l} {W}^{l} ) \qquad [ Equation 10 ]$$

Where, X^{l} and X^{l+1} represent EVCS eigenvalues before and after the extraction of graph convolution, respectively, M̅^{M}=M^{M}+I, D̅_{N}=D_{N}+I, D, I and f represent the degree, identity, and activation functions, respectively.

Owing to the limited availability of EVCSs in the smart energy community, the spatial dependence of EVCSs demand exists over a broad range. For example, the availability condition of one EVCS not only affects the EVCS status in the surrounding regions but also influences the charging demand condition of distant stations. This indicates that there are two types of EVCS demand spatial property, namely, local and global range spatial dependence. To achieve better EVCS demand forecasting results, both the local and global spatial dependencies of the charging demand should be considered. As the layers of graph convolution become deeper, the local extraction ability decreases, resulting in a weaker ability to capture global-range spatial dependence.

Therefore, according to an embodiment of the present disclosure, as shown in FIG. 4, the first-deep learning model (mRGCN) is constructed with a two-layer graph convolutional network block.

By stacking two graph convolution blocks, a first graph convolutional network block can capture the local spatial dependence (local spatial feature value) based on the dynamic graph and temporal sequence data (mutual adjacent matrix).

Additionally, a second graph convolutional network block can capture the global spatial dependence (global spatial feature value) by learning similar EVCS demand patterns from the nearer and more distant areas based on the results of the first graph convolutional network block.

In this way, by stacking two-layer graph convolutional network blocks to construct the first graph convolutional network block, the spatial dependencies can be gradually extracted from the lower level to the upper level.

An activation block may be positioned at the back end of both the first graph convolutional network block and the second graph convolutional network block. Despite employing regularization and other techniques, it is well known that introducing numerous activation functions as the neural network depth increases can degrade performance and negatively impact the training performance of the model.

Therefore, according to an embodiment of the present disclosure, residual elements are applied to balance linear and nonlinear transformations, and ensuring that forecasting accuracy of the first-deep learning model is not compromised by the deep structure of the network. As shown in FIG. 4, the first-deep learning model (mRGCN) can be composed of a combination of two graph convolutional network blocks and a ReLU activation layer. Additionally, the first-deep learning model (mRGCN) can generate a final spatial feature information by combining residual elements with the output of the two graph convolutional network blocks.

$${R}^{l + 1} = f ( {X}^{l} , {M}^{M} ) + {X}^{l} \qquad [ Equation 11 ]$$

Where, R^{l+1} represents the final output of the mRGCN.

In step 120, the computing device (100) can generate a temporal feature information by applying dynamic graph and the temporal sequence data to a second-deep learning model.

The EVCS charging demand is influenced not only by multi-level spatial dependences but also the charging conditions of the previous periods. In an embodiment of the present disclosure, although the residual elements are applied to the first-deep learning model (mRGCN), only the spatial relationship is processed, and the time dependence of the EVCS charging demand sequence is not considered. Therefore, in an embodiment of the present disclosure, the second-deep learning model can be used to learn complex temporal patterns by considering temporal dependency on the EVCS charging related data.

From a temporal perspective, the charging demand variations in EVCSs possess several special characteristics, including periodicity, temporal regularity, and non-linearity.

LSTM model outperforms RMMs in addressing sequence-based tasks with long-term dependencies. The long-term information of the collected dataset is stored to capture the long-term temporal dependencies. Because this, LSTM has been frequency adopted to address temporal dependencies. Since EVCS charging demand exhibits distinct temporal characteristics, LSTM can be utilized to capture key features of time-series variations from the acquired EVCS dataset.

FIG. 5 (a) represents the structure of the LSTM model. The LSTM model includes an input gate it, an output gate oₜ, a forget gate fₜ, which iₜ determines the information to be retained, or determines the output to be generated, and fₜ controls the parts to be discarded. In FIG. 5 (a), The LSTM model has a three-layer structure similar to RNN model, but a hidden layer of the LSTM model has more units to manage the transfer of information. The mathematical formulas for computing the three gates and memory cells in each memory unit are as shown in Equations 12 to 16.

$${i}_{t} = σ ( {W}_{xi} {x}_{t} + {W}_{hi} {h}_{t - 1} + {W}_{ci} {c}_{t - 1} + {b}_{i} ) \qquad [ Equation 12 ]$$

$${o}_{t} = σ ( {W}_{xo} {x}_{t} + {W}_{ho} {h}_{t - 1} + {W}_{co} {c}_{t - 1} + {b}_{i} ) \qquad [ Equation 13 ]$$

$${f}_{t} = σ ( {W}_{xf} {x}_{t} + {W}_{hf} {h}_{t - 1} + {W}_{cf} {c}_{t - 1} + {b}_{f} ) \qquad [ Equation 14 ]$$

$${c}_{t} = {f}_{t} ⊙ {c}_{t - 1} + {i}_{t} ⊙ Tanh ( {W}_{xc} {x}_{t} + {W}_{hc} {h}_{t - 1} + {b}_{c} ) \qquad [ Equation 15 ]$$

$${h}_{t} = {o}_{t} ⊙ Tanh {c}_{t} \qquad [ Equation 16 ]$$

Where, W and b represent a weight matrix and a bias vector for each gate, respectively, σ represents an activation function, which is usually indicated as a sigmoid function. Additionally, ⊙ represents element-wise multiplication, Tanh represents the hyperbolic tangent function. Based on the three gate functions in Equations 12 to 14 and the cell output state (in Equation 15), the hidden layer output in Equation 16 can be derived.

Since the LSTM model utilizes only forward dependencies, it inevitably filters out important information due to the long-term gated memory chain. This problem can be solved by concatenating forward LSTM model and backward LSTM model using the Bidirectional Long Short-Term Memory (Bi-LSTM) model (as shown in FIG. 5(b)). The Bi-LSTM model enhances the ability to mine long-term contextual dependencies in sequential forecasting tasks, leading to more accurate sequence prediction results. The EVCS charging demand exhibits strong periodicity and regularity. By utilizing the backward temporal dependency of the Bi-LSTM, the periodic patterns of charging demand can be derived, enabling comprehensive predictions. The Bi-LSTM model includes two parallel LSTM layers for which the output is expressed as shown in Equations 17 and 19.

$${\vec{h}}_{t} = {LSTM}_{FW} ( {x}_{t} , {\vec{h}}_{t - 1} ) \qquad [ Equation 17 ]$$

$${\overleftarrow{h}}_{t} = {LSTM}_{BW} ( {x}_{t} , {\vec{h}}_{t - 1} ) \qquad [ Equation 18 ]$$

$${b}_{t} = {W}_{{\vec{h}}_{Y}} {\vec{h}}_{t} + {W}_{{\vec{h}}_{Y}} {\vec{h}}_{t} + {b}_{y} \qquad [ Equation 19 ]$$

Where, LSTM_{FW} and LSTM_{BW} represent the forward LSTM and backward LSTM, respectively, \vec{h}ₜ, and [symbol] represent a hidden status of the temporal input features xₜ trained using the Bi-LSTM model. Additionally, and W_{\vec{h}}_{_{Y}} and W_{\vec{h}}_{_{Y}} represent weights of the forward and backward LSTMs, respectively, the bias vector of the Bi-LSTM is denoted as by b_{y}, the final output of the Bi-LSTM model can be obtained as bₜ.

The LSTM and Bi-LSTM can obtain maximum predictabilities by learning temporal patterns through forward and backward propagation, however an EVCS charging demand depends on various dynamic exogenous factors. Therefore, exogenous factors such as time of day, day of the week, past EVCS demand status, average charging rates can be considered by employing an additional multi-layer feedforward neural network prediction model with Bi-LSTM model. Referring to FIG. 6, according to an embodiment of the present disclosure, the second-deep learning model includes a Bi-LSTM and a multi-layer feedforward neural network prediction model.

The b Bi-LSTM can model short-term charging demand dependencies (short charging demand patterns) using the EVCS charging-related data (dynamic graph), and the multi-layer feedforward neural network prediction model, based on weekday-type tend features, can model demand patterns for temporal sequence data.

Let a sample of the time series X₁={xₜ₋ₙ, . . . , xₙ}, and let X₂={t d, s, r}. Where t, d, s and r represent time of day, day of week, past EVCS demand status, average charging rates. X₁ and X₂ represent historical EVCS charging demand sequence and day-type tendency feature sequence, respectively.

The Bi-LSTM model uses X₁ as an input and output of the Bi-LSTM model are then combined with the output of the FNN model which uses X₂ as an input.

The output of the Bi-LSTM model is connected to the FNN model, where the FNN layers and output layer are linked, enabling the output of multi-step ahead charging demand predictions.

To summarize, by combining the Bi-LSTM model and the FNN model, the over temporal dependencies can be modeled through the Bi-LSTM model, while the day-type tendency features can be processed through the multi-layer FNN model.

Unlike the conventional approach, which only considers time-related EVCS demand features through recurrent networks, an embodiment of the present disclosure can be improve prediction accuracy by combining heterogeneous features.

To obtain a final temporal feature output cₜ, the outputs of the Bi-LSTM model and the FNN layers are concatenated, then followed by an FNN layer with dropout applied.

$${c}_{t} = {W}_{c} ( {o}_{t}^{Bi} ‖ {o}_{t}^{FNN} ) + {b}_{t} \qquad [ Equation 20 ]$$

Where, W_{c}, bₜ,

$${o}_{t}^{FNN}$$

represent the trainable weight, bias, and output of the multi-layer feedforward neural prediction model, respectively, for generating the final output of the second-deep learning model, ∥ represents a concatenating operator.

The charging demand prediction model according to an embodiment of the present disclosure is shown in FIG. 7. As shown in FIG. 7, the charging demand prediction model can perform target time step prediction by combining the first-deep learning model, which is a relational graph convolution-based model, and the second-deep learning model, which is a bidirectional LSTM-based model, in parallel.

To this end, as shown in FIG. 7, EVCS-related data consists of two forms: dynamic graph and temporal sequence data, as previously described.

By applying the dynamic graph and the temporal sequence data to the first-deep learning model and the second-deep learning model, respectively, spatial dependencies (spatial feature information) and the temporal dependencies (temporal feature information) can be learned separately.

In step 125, the computing device (100) outputs hourly EVCS charging demand prediction values by combining the spatial feature information and temporal feature information, which are the outputs of the first-deep learning model and the second-deep learning model.

If the outputs of the first-deep learning model and the second-deep learning model are represented as R^{k} and C^{m}, respectively, a final output of the charging demand prediction model can be expressed as shown in Equation 21.

$$Y = {W}_{st} ( {R}^{k} ‖ {C}^{m} ) + {b}_{st} \qquad [ Equation 21 ]$$

Where, k and m represent numbers of hidden units in the last layer of the first-deep learning model and the second-deep learning model, respectively, W and b, represent the trainable weight and bias parameters, respectively, used to obtain the final prediction results, Y.

Based on the EVCS charging demand prediction model according to an embodiment of the present disclosure, an EVCS operation method will be briefly explained with reference to FIG. 8. For ease of understanding and explanation, the description will be based on CAISO.

In retail electricity markets that are liberalized to enable electricity users to manage their electricity costs using various purchase options. EVCS owners can participate in the retail electricity market as retailers, and EVCS owners can obtain profit by purchasing power from the energy market and selling it to EV users. The main goal of an optimal bidding procedure for EVCSs is to maximize the profits of the EVCS owners to facilitate the integration of EVs into the power system and the increased adoption of such vehicles.

In an embodiment of the present disclosure, in the Day-Ahead Market (DAM), the aggregator can submit bids for the next 24 hours based on the hourly prediction values of the aggregated EVCS charging demand obtained through the EVCS charging demand prediction model, thereby maximizing the benefits of the EVCS. When entering the actual operating day, in the Real-Time Market (RTM), the aggregator needs to submit additional bids due to the underestimation of the actual charging demand with the EVCS. This results in penalty costs for failing to fulfill the DAM bids.

This situation arises from the deviation of actual charging power from EVCSs, creating a closed-loop model with feedback loops from EV users and the energy market. For example, the EV users tend to charge when RT price is low on actual charging day. Afterwards, based on actual charging demand, the EVCS aggregator submits additional incremental RT bids to the RTM, and the RT settlement is announced every 15 minutes to fulfill the increased charging demand when RT prices is low.

In the CAISO energy market, the awarded DAM bids are binding, and market customers are required to consume their awarded DAM bids in the following day. Although EVCS aggregator can opt to adjust its submitted DAM bids in the RTM, they can only submit incremental bids. If a customer does not comply with the DAM bidding results, they will be recovered and will be incur a penalty cost.

In this market context, the EVCS aggregator must first forecast its DA power demand and submit a DAM power bid accordingly. Subsequently, in the RTM the aggregator adjusts its purchasing power to ensure the charging demand for EVCS power while following the DA bids. Therefore, the prediction accuracy of EVCS charging demand plays a crucial role in the economic gains of the EVCS aggregator in the energy market.

The EVCS aggregator can be an intermediary that predicts the charging demand of all EVCSs using the charging demand prediction model according to an embodiment of the present disclosure and participates in the electricity markets on their behalf. It is assumed that the EVCS aggregator sells electricity to EVs in order to maximize the profits of each EVCS and minimize charging costs in both DAM and RTM.

The objective function of an EVCS aggregator participating in the DAM is to maximize the net profit formulated as shown in Equation 22.

$$max {\sum }_{h = 1}^{H} ( {P}_{sell}^{h} \cdot {π}_{sell}^{h} - {P}_{DAM}^{h} \cdot {π}_{DAM}^{h} ) \qquad [ Equation 22 ]$$

Where,

$${P}_{sell}^{h} , {P}_{DAM}^{h} , {π}_{sell}^{h} , and {π}_{DAM}^{h}$$

represent power sold to EV users, DAM market bids, power sold to the EVCS at hour h, and DAM price at hour h, respectively. Equation 22 aims to maximize the total aggregator profit, which includes the profit from selling power to EV users and the DAM power cost for energy bids submitted to meet EVCS charging demand.

Additionally, in the second part of the optimization problem, the performance of the EVCS aggregator on the bidding date can be evaluated using Equation 23. Although the EVCS aggregator implements the proposed spatiotemporal forecasting model in the DA stage, in practice there will always be mismatches between the predicted and actual charging values. Thus, the aggregator should adjust its power bids to meet EVCS charging demands while following the awarded DAM bids. Equation 23 aims to adjust the overall performance of the EVCS aggregator in the power market and the role that the EVCSs charging demand forecasts play thereof.

$$min {\sum }_{τ = {h}_{o}}^{τ + Δ {H}_{h}} ( {P}_{Inc}^{τ} \cdot {π}_{RTM}^{τ} + {P}_{Pen}^{τ} \cdot {π}_{P , RTM}^{τ} ) \qquad [ Equation 23 ]$$

$${P}_{DAM}^{τ} - {P}_{Pen}^{τ + Δ H} + {P}_{Inc}^{τ + Δ H} = {P}_{RTM}^{τ + Δ H} \qquad [ Equation 24 ]$$

$$0 \leq {P}_{Inc}^{τ + Δ H} , 0 \leq {P}_{Pen}^{τ + Δ H} \leq {P}_{DAM}^{τ} \qquad [ Equation 25 ]$$

Where, h₀ and ΔHₕ represent the initial time and length of the scheduling period of rolling horizon optimization, respectively.

$${P}_{Inc}^{τ} , {P}_{Pen}^{τ} and {P}_{RT}^{τ}$$

represent the incremental purchasing power in the RTM, the amount of power required to not be able to consume the honored DAM bids, and the purchasing power in the RTM at time T, respectively. The prices

$${π}_{RTM}^{τ} and {π}_{P , RTM}^{τ}$$

represent the price of purchasing power and penalty for not honoring the DAM bids, respectively. Equation 23 includes the costs of purchasing additional power demand from the RTM and not being able to follow awarded DAM bids, constraint 24 reflects the nature of the awarded DAM bids, and constraint 25 ensures the amounts of power P_{Inc}^{τ+ΔH} and P_{Pen}^{τ+ΔH}.

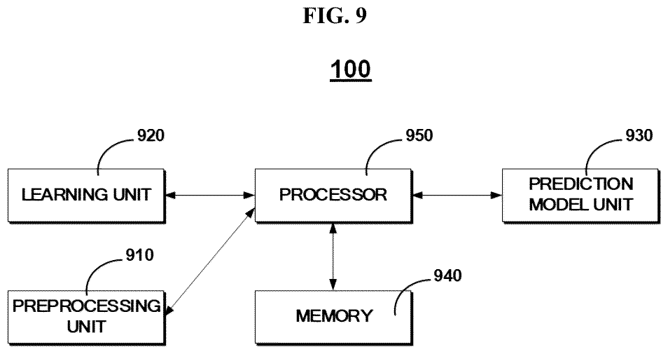

FIG. 9 is a block diagram schematically illustrating the internal configuration of a computing device according to an embodiment of the present disclosure.

Referring to FIG. 9, the computing device (100) according to an embodiment of the present disclosure is configured to include a preprocessing unit (910), a learning unit (920), a prediction model unit (930), a memory (940), and a processor (950).

The preprocessing unit (910) is a mean of dividing the EVCS (Electric Vehicle Charging Station) related data into dynamic graph and temporal sequence data. This is the same as described earlier in FIG. 1, so redundant explanations will be omitted.

The learning unit (920) is a mean for training the EVCS charging demand prediction model using a training dataset (dynamic graph, temporal sequence data, and ground truth data).

The prediction model unit (930) is a mean for applying dynamic graph and temporal sequence data to the EVCS charging demand prediction model to generate time-space feature information, and using this information to generate hourly EVCS charging demand prediction results.

More specifically, the prediction model unit (930) can generate spatial feature information by applying dynamic graph and temporal sequence data to the relationship graph convolution-based first-deep learning model of the EVCS charging demand prediction model. Then, the prediction model unit (930) can generate temporal feature information by applying dynamic graph and temporal sequence data to the bidirectional LSTM-based second-deep learning model. Subsequently, the prediction model unit (930) can output the hourly charging demand prediction results for the EVCS by combining the spatial feature information and temporal feature information.

The detailed explanation of this is the same as described with reference to FIGS. 1 to 7, so redundant explanations will be omitted.

The memory (940) stores various instructions (program codes) to perform the spatial-temporal graph convolution-based electric vehicle charging demand prediction method according to one embodiment of the present disclosure.

The processor (950) is a means for controlling the internal components of the computing device (100) according to one embodiment of the present disclosure, such as the preprocessing unit (910), learning unit (920), prediction model unit (930), memory (940), and others.

The apparatus and the method according to the embodiment of the present disclosure may be implemented in a form of program commands that may be executed through various computer means and may be recorded in a computer-readable recording medium. The computer-readable recording medium may include a program command, a data file, a data structure, or the like, alone or in a combination thereof. The program commands recorded in the computer-readable recording medium may be especially designed and constituted for the present disclosure or be known to and usable by those skilled in a field of computer software. Examples of the computer-readable recording medium may include magnetic media such as a hard disk, a floppy disk, and a magnetic tape; optical media such as a compact disk read only memory (CD-ROM) or a digital versatile disk (DVD); magneto-optical media such as a floptical disk; and a hardware device specially configured to store and execute program commands, such as a ROM a random access memory (RAM), a flash memory, or the like. Examples of the program commands include a high-level language code capable of being executed by a computer using an interpreter, or the like, as well as a machine language code made by a compiler.

The above-mentioned hardware device may be constituted to be operated as one or more software modules in order to perform an operation according to the present disclosure, and vice versa.

Hereinabove, the present disclosure has been described with reference to exemplary embodiments thereof. It will be understood by those skilled in the art to which the present disclosure pertains that the present disclosure may be implemented in a modified form without departing from essential characteristics of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

What is claimed is:

1. A spatial-temporal graph convolution-based electric vehicle charging demand prediction method, comprising:
(a) dividing electric vehicle charging station (EVCS) related data into a dynamic graph and temporal sequence data;
(b) generating spatial feature information by applying the dynamic graph and the temporal sequence data to a first-deep learning model based on relational graph convolution;
(c) generating temporal feature information by applying the dynamic graph and the temporal sequence data to a second-deep learning model based on bidirectional long short-term memory (LSTM); and
(d) outputting hourly EVCS charging demand predictions by combining the spatial feature information and the temporal feature information.

2. The method of claim 1,
wherein the dynamic graph is a temporal graph that includes location information for each EVCS over a continuous time series and spatial correlations related to charging demand data.

3. The method of claim 2,
wherein the temporal sequence data is a mutual adjacency matrix generated using static attributes based on the location information for each EVCS and dynamic attributes that affect the charging demand of the EVCS.

4. The method of claim 3,
wherein the mutual adjacency matrix is generated by calculating distances between EVCSs using the location information of each EVCS, constructing a distance matrix using the distances between EVCSs, forming a dynamic feature correlation matrix based on a charging demand relationship with adjacent EVCSs using Pearson correlation coefficients, constructing a charging comfort matrix based on weather information, constructing a charging exogenous factor matrix according to weekday information considering holidays and commuting, and combining the distance matrix, the dynamic feature correlation matrix, the charging comfort matrix and the charging exogenous factor matrix.

5. The method of claim 3,
wherein the first-deep learning model derives a residual element using the temporal graph and the mutual adjacency matrix, and generates the spatial feature information by adding the residual element to a result of applying the temporal graph and the mutual adjacency matrix to a relational graph convolution-based model.

6. The method of claim 5,
wherein the first deep-learning model comprises:
a first graph convolutional network block configured to receive the temporal graph and the mutual adjacency matrix as input, and extract a local spatial feature value for local spatial dependency that reflects a charging demand pattern of EVCSs located at adjacent distances; and
a second graph convolutional network block configured to extract a global spatial feature value for global spatial dependency that reflects a state and a charging demand pattern of EVCSs located at distant positions using the local spatial feature value which is an output of the first graph convolutional network block,
wherein the spatial feature information is generated by adding the residual element to the global spatial feature value.

7. The method of claim 1,
wherein the temporal sequence data is a day-type tendency feature sequence that includes a time of day, a day of week, a past charging demand status and average charging rates.

8. The method of claim 2,
wherein the second-deep learning model comprises:
a multi-layer feed-forward neural network model configured to receive the temporal sequence data and generate an output vector reflecting an EVCS demand pattern; and
a bidirectional LSTM model configured to receive the temporal graph and output a temporal feature vector;
wherein the temporal feature information is generated by combining the output vector of the multi-layer feed-forward neural network model and the temporal feature vector of the bidirectional LSTM model.

9. A non-transitory computer-readable recording medium in which a program code for performing the method according to claim 1 is recorded.

10. A computing device, comprising:
a preprocessing unit configured to divide electric vehicle charging station (EVCS) related data into a dynamic graph and temporal sequence data; and
a prediction model unit configured to generate spatial feature information by applying the dynamic graph and the temporal sequence data to a first-deep learning model based on relational graph convolution, generate temporal feature information by applying the dynamic graph and the temporal sequence data to a second-deep learning model based on bidirectional long short-term memory (LSTM), and output hourly EVCS charging demand predictions by combining the spatial feature information and the temporal feature information.

11. The computing device of claim 10,
wherein the dynamic graph is a temporal graph that includes location information for each EVCS over a continuous time series and spatial correlations related to charging demand data.

12. The computing device of claim 11,
wherein the temporal sequence data is a mutual adjacency matrix generated using static attributes based on the location information for each EVCS and dynamic attributes that affect the charging demand of the EVCS.

13. The computing device of claim 12,
wherein the preprocessing unit is configured to calculate distances between EVCSs using the location information of each EVCS, construct a distance matrix using the calculated distances between EVCSs, form a dynamic feature correlation matrix based on a charging demand relationship with adjacent EVCSs using Pearson correlation coefficients, construct a charging comfort matrix based on weather information, construct a charging exogenous factor matrix according to weekday information considering holidays and commuting, and generate the mutual adjacency matrix by combining the distance matrix, the dynamic feature correlation matrix, the charging comfort matrix, and the charging exogenous factor matrix.

14. The computing device of claim 12,
wherein the first-deep learning model derives a residual element using the temporal graph and the mutual adjacency matrix, and generates the spatial feature information by adding the residual element to a result of applying the temporal graph and the mutual adjacency matrix to a relational graph convolution-based model.

15. The computing device of claim 14,
wherein the first deep-learning model comprises:
a first graph convolutional network block configured to receive the temporal graph and the mutual adjacency matrix as inputs, and extract a local spatial feature value for local spatial dependency that reflects a charging demand pattern of EVCSs located at adjacent distances;
a second graph convolutional network block configured to extract a global spatial feature value for global spatial dependency that reflects a state and a charging demand pattern of EVCSs located at distant positions using the local spatial feature value, which is an output of the first graph convolutional network block,
wherein the spatial feature information is generated by adding the residual element to the global spatial feature value.

16. The computing device of claim 14,
wherein the second-deep learning model comprises:
a multi-layer feed-forward neural network configured to receive the temporal sequence data and generate an output vector reflecting an EVCS demand pattern;
a bidirectional LSTM model configured to receive the temporal graph and output a temporal feature vector;
wherein the temporal feature information is generated by combining the output vector of the multi-layer feed-forward neural network and the temporal feature vector of a bidirectional long short-term memory (Bi-LSTM) model.
